(19) United States
(12) Patent Application Publication
(10) Pub. No.: US 2005/0014919 A1
(43) Pub. Date: Jan. 20, 2005

(54) Lignin-based polyurethane and process for producing the same

(76) Inventors: Hyoe Hatakeyama, Nyu-gun (JP); Shigeo Hirose, Matsudo-shi, Chiba-ken (JP)

Correspondence Address: George A Loud;Lorusso Lound & Kelly, 3137 Mount Vernon Avenue, Alexandria, VA, 22305, US

(21) Appl. No.: 10/479,592

(22) PCT Filed: Jun. 14, 2002
(86) PCT No.: PCT/JP02/05974

(30) Foreign Application Priority Data
Jun. 15, 2001 (JP) 2001-182611
Jul. 24, 2001 (JP) 2001-223028

(51) Int. Cl. C08G 18/00

(52) U.S. Cl. 527/400; 528/44

(57) ABSTRACT

Provided is a polyurethane which is inexpensive and excellent in physical properties and which contains a lignin sulfonic acid component incorporated into the molecular chain of the polyurethane. The polyurethane is obtainable by polycondensation of a polyol solution containing dissolved therein lignin sulfonic acid or a partially neutralized salt thereof with a polyisocyanate, wherein the content of said lignin sulfonic acid is 1-40% based on a total weight of said polyurethane.

### TECHNICAL FIELD

The present invention relates to a lignin-based polyurethane and to a process of producing same.

### BACKGROUND ART

The present inventors found in the past that biodegradable polyurethanes produced from sugars such as monosaccharides and oligosaccharides or from lignins such as solvolysis lignin and craft lignin had excellent physical properties and that the physical properties were further improved when sugars and lignin were used conjointly.

As a lignin-based material, known is a lignin sulfonate which is a by-product in a sulfite pulp manufacturing process. Because the lignin sulfonate is, however, insoluble in a polyol, it is extremely difficult to incorporate same into polyurethane molecules.

The present inventors have found that lignin sulfonic acid in an acid form or a partially neutralized salt thereof is soluble in a polyol and can be incorporated into molecular chains of a polyurethane. It has also been found that the thus obtained polyurethane has excellent physical properties.

It is an objective problem of the present invention to provide a polyurethane which is inexpensive and excellent in physical properties and which contains lignin sulfonic acid or a partially neutralized salt thereof incorporated into the molecular chain of the polyurethane.

### DISCLOSURE OF THE INVENTION

In accordance with the present invention, there are provided a lignin-based polyurethane and a process of producing same as follows:
(1) A polyurethane obtainable by polycondensation of a polyol solution containing dissolved therein lignin sulfonic acid or a partially neutralized salt thereof with a polyisocyanate, wherein the content of the lignin sulfonic acid or a partially neutralized salt thereof is 1 to 40% based on a total weight of said polyurethane.
(2) A polyurethane as recited in item (1) above, wherein the polycondensation is performed in the presence of water so that the polyurethane is in the form of a foam.
(3) A process of producing a polyurethane, comprising subjecting a polyol solution containing dissolved therein lignin sulfonic acid or a partially neutralized salt thereof to polycondensation with a polyisocyanate, wherein the content of the lignin sulfonic acid or a partially neutralized salt thereof is 1 to 40% based on a total weight of the polyurethane.
(4) A process as recited in item (3) above, wherein the polycondensation is performed in the presence of water so that the polyurethane is in the form of a foam.

### BEST MODE FOR CARRYING OUT THE INVENTION

The term “partially neutralized salt of lignin sulfonic acid” as used herein is intended to refer to a lignin material which has both sulfonic acid groups and sulfonate groups and which is soluble in a polyol. The partially neutralized salt of lignin sulfonic acid can be obtained by hydrolyzing a lignin sulfonate using an acid or by ion-exchanging a lignin sulfonate using a cation exchanging method. While lignin sulfonates are inexpensive materials obtained as by-products in a sulfite pulping process, they are insoluble in polyols. Therefore, no polyurethanes have been hitherto known which are produced using, as a raw material, lignin sulfonates as such. Hitherto known is only a polyurethane in which a lignin sulfonate is made soluble in a polyol by hydroxymethylation and is then incorporated into the polyurethane molecules. Such polyurethane requires a high production cost and fails to make use of the inexpensiveness of the lignin sulfonate.

The present inventors have found that a partially neutralized lignin sulfonate obtained by partial hydrolysis of a lignin sulfonate using an acid is easily soluble in a polyol and that a biodegradable polyurethane having excellent physical properties and containing a lignin sulfonic acid component incorporated into the polyurethane molecular chain can be obtained by subjecting a polyol solution containing dissolved therein the partially neutralized lignin sulfonate to polycondensation with a polyisocyanate. The present invention has been completed on the basis of the above finding.

The partially neutralized lignin sulfonate may be obtained by partially hydrolyzing a lignin sulfonate using an acid or by partially cation-exchanging a lignin sulfonate using an ion exchanging method. Examples of the lignin sulfonate include a sodium salt, a potassium salt, an ammonium salt, a calcium salt and a magnesium salt. The partial hydrolysis may be carried out in such a degree that the pH of a 5% by weight aqueous solution of the partially neutralized lignin sulfonate is in the range of 1 to 8, preferably 2.5 to 6, more preferably 3 to 4 and that the partially neutralized lignin sulfonate is soluble in a polyol.

The sulfonic acid groups of a partially neutralized lignin sulfonate may be partially desulfonated. The desulfonation may be carried out before the partial hydrolysis of the lignin sulfonate. The desulfonation may be performed by oxidizing the lignin sulfonate in an alkaline condition at an elevated temperature and a high pressure. It is preferred that 5 to 90% by weight, more preferably 10 to 50% of the sulfonic acid groups contained in the lignin be desulfonated.

The present invention is characterized in that lignin sulfonic acid (lignosulfonic acid) or a partially neutralized salt thereof is dissolved in a polyol and is used in the form of a polyol solution.

In the present invention, molasses and/or sugar compounds may be dissolved in a polyol together with lignin sulfonic acid or a partially neutralized salt thereof, if necessary. As the molasses, waste molasses may be preferably used from the standpoint of costs, though purified molasses may be used. Any sugar compound such as a monosaccharide, an oligosaccharide, a polysaccharide or a sugar alcohol, may be used as long as it is soluble in a polyol. Examples of the sugar compounds include glucose, galactose, xylose, lactose, mannose, talose, rhamnose, arabinose, glucosylmannose, lyxose, allose, altrose, gulose, idose, ribose, erythrose, threose, psicose, fructose, sorbose, tagatose, pentuloses, tetroses, sucrose, maltose, isomaltose, cellobiose, lactose, trehalose, kojibiose, sophorose, nigerose, laminaribiose, isomaltose, gentiobiose, melibiose, planteobiose, turanose, vicianose, agarobiose, solabiose, rutinose, primevelose, xylobiose, erythritol, mesoerythritol, maltitol, lactitol, threitol, arabinitol, ribitol, xylitol, sorbitol, galactitol, D-mannitol, allitol and higher alditols, and rest, starch, dextran, mannan, pectin, pectin acid, alginic acid and chitosan.

The polyol used for the purpose of the present invention may be, for example, a low molecular weight polyol such as ethylene glycol, diethylene glycol, triethylene glycol, 1,4-butanediol, 1,6-hexanediol, neopentyl alcohol, trimethylolpropane, glycerin, triethanolamine or sorbitol; a polyether polyol such as polyethylene glycol, polypropylene glycol, polytetramethylene glycol or an ethylene oxide/propylene oxide copolymer; polycaprolactone, poly-β-methyl-δ-butylolactone or a polyester of a diol with a dibasic acid. There may be also mentioned hydroxyl group-containing liquid polybutadiene, polycarbonate diol and acrylic polyol.

The polyisocyanate used for the purpose of the present invention may be an aliphatic polyisocyanate, cycloaliphatic polyisocyanate, an aromatic polyisocyanate and modified compounds thereof. Examples of the aliphatic polyisocyanate include hexamethylenediisocyanate, lysinediisocyanate and lysinetriisocyanate. The cycloaliphatic polyisocyanate may be, for example, isophoronediisocyanate. Examples of the aromatic polyisocyanate include tolylenediisocyanate, xylylenediisocyanate, diphenylmethanediisocyanate, polymeric diphenylmethanediisocyanate, triphenylmethane-diisocyanate and tris(isocyanatephenyl)thiophosphate. Examples of the modified polyisocyanate include urethane prepolymer, buret-modified hexamethylenediisocyanate, hexamethylenediisocyanate trimer and isophoronediisocyanate trimer.

The polyurethane according to the present invention may be obtained by polycondensation of a polyol solution containing dissolved therein lignin sulfonic acid or a partially neutralized salt thereof with a polyisocyanate. In this case, a foamed polyurethane (polyurethane foam) may be obtained, when water is present in the reaction system.

The reaction may be carried out in the presence of a catalyst. As the catalyst, there may be used any conventionally known urethanation catalyst. A tin-based catalyst or an amine-based catalyst is generally used. The reaction temperature may be ambient temperature but, if necessary, an elevated temperature may be used.

The amount of the polyisocyanate relative to the polyhydric alcohol inclusive of the lignin sulfonic acid or its partially neutralized salt and the optional molasses and/or sugar compound (hereinafter referred to as hydroxyl group component) is as follows. Namely, the amount of the polyisocyanate is such that the isocyanate groups of the polyisocyanate are in the range of 0.8 to 2 times the equivalent, preferably 1 to 1.5 times the equivalent, of the total hydroxyl groups contained in the hydroxyl group component.

The amount of the lignin sulfonic acid or its partially neutralized salt and the optional molasses and/or sugar compound is in the range of 0.1 to 50% by weight, preferably 1 to 45% by weight, based on the whole hydroxyl group component. The amount of the lignin sulfonic acid is 1 to 40% by weight, preferably 2 to 20% by weight, more preferably 5 to 15% by weight, based on the whole polyurethane. By using a polyol containing lignin sulfonic acid or its partially neutralized salt as reactants, it is possible to obtain a polyurethane which is excellent in biodegradability and which has improved mechanical strengths.

The polyurethane of the present invention may be a hard polyurethane foam. The apparent density (weight/volume) of the foam may be controlled by the amount of water (blowing agent) added to the reaction raw materials. The amount of water is about 0.001 to 0.3 mole, preferably 0.005 to 0.05 mole, per mole of the polyisocyanate. The apparent density (weight/volume of the polyurethane foam) of the foam is 0.01 to 0.9 g/cm³, preferably 0.05 to 0.5 g/cm³.

### EXAMPLE

The following examples will further illustrate the present invention in detail.

### Example 1

One part of lignin sulfonic acid (LS) was dissolved in 2 parts of polyethylene glycol 200 (molecular weight: 200) to prepare lignin sulfonic acid-polyol (LSP). This LSP was mixed with quantities of polyethylene glycol 200 to obtain polyol mixtures. One part of each polyol mixture was mixed with a catalytic amount of a tin-based catalyst, water and a silicone foam stabilizer, to which diphenylmethanediisocyanate (MDI) was added in an amount providing a NCO/OH molar ratio of 1-0.2. The resulting mixture was vigorously stirred at room temperature to obtain a polyurethane foam. The glass transition temperature (Tg), thermal decomposition temperature (Td) ° C., apparent density (ρ) g/cm³, compression strength/apparent density ratio (σ/ρ) MPa/g·cm⁻³, and compression modulus/apparent density ratio (E/ρ) MPa/g·cm⁻³ of the thus obtained polyurethane foams are shown in Table 1.

TABLE 1

| | LSP | LS | | | | | |
|---|---|---|---|---|---|---|---|
| | Content | Content | | | | | |
| | in | in | | | | | |
| Foam | Polyol | Polyol | Tg | Td | | | |
| No. | (%) | (%) | (° C.) | (° C.) | ρ | σ/ρ | E/ρ |
| 1-1 | 0 | 0 | 63 | 305 | | | |
| 1-2 | 10 | 3.3 | 64 | 299 | | | |
| 1-3 | 20 | 6.7 | 61 | 298 | 0.1 | 10 | 330 |
| 1-4 | 30 | 10 | 58 | 294 | | | |
| 1-5 | 40 | 13.3 | 59 | 296 | | | |
| 1-6 | 50 | 16.7 | 60 | 294 | 0.08 | 7.9 | 350 |
| 1-7 | 60 | 20.0 | 44 | 290 | | | |
| 1-8 | 70 | 23.3 | 38 | 289 | | | |
| 1-9 | 80 | 26.7 | 40 | 290 | 0.12 | 10 | 217 |
| 1-10 | 90 | 30.0 | 39 | 292 | | | |
| 1-11 | 100 | 33.3 | 60 | 290 | | | |

### Example 2

One part of waste molasses was dissolved in 2 parts of polyethylene glycol 200 (molecular weight: 200) to prepare molasses-polyol (MP). This MP was mixed with quantities of LSP obtained in Example 1 to prepare polyol mixtures. One part of each polyol mixture was mixed with one part of polyethylene glycol, a catalytic amount of a tin-based catalyst, water and a silicone foam stabilizer, to which diphenylmethanediisocyanate (MDI) was added in an amount providing a NCO/OH molar ratio of 1.2. The resulting mixture was vigorously stirred at room temperature to obtain a polyurethane foam. The glass transition temperature (Tg), thermal decomposition temperature (Td), apparent density (ρ), compression strength/apparent density ratio (σ/ρ), and compression modulus/apparent density ratio (E/ρ) of the thus obtained polyurethane foams are shown in Table 2.

TABLE 2

| | LSP | LS | | | | | |
|---|---|---|---|---|---|---|---|
| | Content | Content | | | | | |
| | in | in | | | | | |
| Foam | Polyol | Polyol | Tg | Td | | | |
| No. | (%) | (%) | (° C.) | (° C.) | ρ | σ/ρ | E/ρ |
| 2-1 | 20 | 6.7 | 93 | 289 | 0.1 | 5 | 180 |
| 2-2 | 40 | 13.3 | 82 | 290 | | | |
| 2-3 | 60 | 20.0 | 84 | 291 | 0.12 | 4.3 | 158 |
| 2-4 | 80 | 26.7 | 81 | 290 | | | |
| 2-5 | 100 | 33.3 | 83 | 291 | 0.13 | 4.8 | 192 |

### Example 3

Example 1 was repeated in the same manner as described except that partially neutralized salt of lignosulfonic acid was substituted for the lignosulfonic acid, thereby to obtain polyurethane foams. The physical properties of the polyurethane foams are shown in Table below.

The partially neutralized salt of lignosulfonic acid has a structure in which part of the sulfonic acid groups of lignosulfonic acid are converted to corresponding sodium salt and is soluble in water and in a polyol. A 5% by weight aqueous solution of the salt shows a pH of 3.5.

TABLE 3

| | LSP | LS | | |
|---|---|---|---|---|
| | Content | Content | | |
| | in | in | | |
| Foam | Polyol | Polyol | Tgm | Tdm |
| No. | (%) | (%) | (° C.) | (° C.) |
| 3-1 | 0 | 0 | 78 | 339 |
| 3-2 | 20 | 6.6 | 90 | 325 |
| 3-3 | 40 | 12.3 | 101 | 317 |
| 3-4 | 60 | 18.9 | 111 | 314 |
| 3-5 | 80 | 26.4 | 117 | 313 |
| 3-6 | 100 | 33.3 | 123 | 312 |

### Example 4

Example 3 was repeated in the same manner as described except that diethylene glycol was substituted for the PEG200. The physical properties of the polyurethane foams are shown in Table 4.

TABLE 4

| | LSP | LS | | |
|---|---|---|---|---|
| | Content | Content | | |
| | in | in | | |
| Foam | Polyol | Polyol | Tgm | Tdm |
| No. | (%) | (%) | (° C.) | (° C.) |
| 4-1 | 0 | 0 | 126 | 325 |
| 4-2 | 20 | 6.6 | 135 | 316 |
| 4-3 | 40 | 12.3 | 143 | 317 |
| 4-4 | 60 | 18.9 | 154 | 314 |
| 4-5 | 80 | 26.4 | 154 | 313 |
| 4-6 | 100 | 33.3 | 158 | 310 |

### INDUSTRIAL APPLICABILITY

According to the present invention, a biodegradable polyurethane which contains a lignin sulfonic acid component incorporated into a molecular chain thereof and which has excellent mechanical properties can be obtained at a low cost.

1. A polyurethane obtainable by polycondensation of a polyol solution containing dissolved therein lignin sulfonic acid or a partially neutralized salt thereof with a polyisocyanate, wherein the content of said lignin sulfonic acid or a partially neutralized salt thereof is 1 to 40% based on a total weight of said polyurethane.

2. A polyurethane as recited in claim 1, wherein said polycondensation is performed in the presence of water so that said polyurethane is in the form of a foam.

3. A process of producing a polyurethane, comprising subjecting a polyol solution containing dissolved therein lignin sulfonic acid or a partially neutralized salt thereof to polycondensation with a polyisocyanate, wherein the content of said lignin sulfonic acid or a partially neutralized salt thereof is 1 to 40% based on a total weight of said polyurethane.

4. A process as recited in claim 3, wherein said polycondensation is performed in the presence of water so that said polyurethane is in the form of a foam.
